(19) United States
(12) Patent Application Publication
(10) Pub. No.: US 2026/0054588 A1
(43) Pub. Date: Feb. 26, 2026

(54) ROOFTOP SOLAR CHARGING DEVICE AND VEHICLE

(71) Applicant: Gaotu New Energy Technology (Shenzhen) Co., Ltd., Shenzhen (CN)

(72) Inventor: Zhiyi GAO, Shenzhen (CN)

(73) Assignee: Gaotu New Energy Technology (Shenzhen) Co., Ltd., Shenzhen (CN)

(21) Appl. No.: 18/918,357

(22) Filed: Oct. 17, 2024

(30) Foreign Application Priority Data
Aug. 21, 2024 (CN) 202411152431.X

(51) Int. Cl. B60L 53/51; B60L 53/16; B60L 53/18; B60L 53/53; H02S 20/30; H02S 30/20; H02S 40/38

(52) U.S. Cl. CPC B60L 53/51; B60L 53/16; B60L 53/18; B60L 53/53; H02S 20/30; H02S 30/20; H02S 40/38

(57) ABSTRACT

Disclosed are a rooftop solar charging device and a vehicle. The rooftop solar charging device includes: a box body, a cover body, a battery and a first solar panel assembly. The box body is fixed on a top of a vehicle body; the cover body is provided on one side of the box body away from the vehicle body; the opening and closing apparatus is provided on one of the box body and the cover body and connected to the other one of the box body and the cover body in a driving manner, the cover body and the box body are buckled to form an accommodation space, and the cover body and the box body are separated to open the accommodation space; the battery is provided inside the accommodation space; and the first solar panel assembly is electrically connected to the battery.

### CROSS-REFERENCE TO RELATED APPLICATIONS

The present application claims priority to Chinese Patent Application No. 202411152431.X, filed on Aug. 21, 2024, the entire contents of which are incorporated herein by reference.

### TECHNICAL FIELD

The present application relates to the technical field of vehicle, and in particular to a rooftop solar charging device and a vehicle.

### BACKGROUND

With the increasingly serious problems of energy crisis, environmental pollution and greenhouse effect, the development of new energy vehicles, especially electric vehicles, has become an inevitable trend of change in the automotive industry.

Currently, electric vehicles generally use battery packs as power sources. However, the energy storage capacity and charging efficiency of the battery restrict the vehicle's endurance to a certain extent, resulting in the problem that the vehicle is easily broken down in the wild.

### SUMMARY

The main purpose of the present application is to provide a rooftop solar charging device and vehicle, aiming to reduce the possibility of vehicle breaking down in the wild.

To achieve the above purpose, the rooftop solar charging device provided in the present application includes: a box body, a cover body, a battery and a first solar panel assembly.

The box body is fixed on a top of a vehicle body; the cover body is provided on one side of the box body away from the vehicle body; the opening and closing apparatus is provided on one of the box body and the cover body and connected to the other one of the box body and the cover body in a driving manner, the cover body and the box body are buckled to form an accommodation space, and the cover body and the box body are separated to open the accommodation space; the battery is provided inside the accommodation space; and the first solar panel assembly is electrically connected to the battery, having a storage status accommodated inside the accommodation space and an unfolded status unfolded outside the accommodation space; in response to that the accommodation space is opened, the first solar panel assembly is configured to switch between the storage status and the unfolded status.

In an embodiment, the first solar panel assembly includes:
a horizontal solar panel rotatably connected to the box body and electrically connected to the battery, the horizontal solar panel is accommodated inside the accommodation space or unfolded outside the accommodation space along a width direction of the vehicle body through rotation; and
a vertical solar panel rotatably connected to the box body and electrically connected to the battery, the vertical solar panel is accommodated inside the accommodation space or unfolded outside the accommodation space along a length direction of the vehicle body through rotation.

In an embodiment, the rooftop solar charging device further includes a first traction member made of a flexible material, one end of the first traction member is connected to the box body, and the other end of the first traction member is connected to the cover body or the opening and closing apparatus; and in a process of the cover body opening the accommodation space, the first traction member is configured to drive the horizontal solar panel to rotate in a direction of separating from the accommodation space.

In an embodiment, the rooftop solar charging device further includes a second traction member made of a flexible material, one end of the second traction member is connected to the box body, and the other end of the second traction member is connected to the cover body or the opening and closing apparatus, and in a process of the cover body opening the accommodation space, the second traction member is configured to drive the vertical solar panel to rotate in a direction of separating from the accommodation space.

In an embodiment, the opening and closing apparatus includes:
a scissor assembly including two support arms, middle parts of the two support arms are crossed and rotatably connected, and top ends of the two support arms are slidably connected to the cover body; and
a driving assembly connected to bottom ends of the two support arms in a driving manner.

The driving assembly is configured to drive the bottom ends of the two support arms to approach each other, so that the cover body is configured to move away from the box body to open the accommodation space; or the driving assembly is configured to drive the bottom ends of the two support arms to move away from each other, so that the cover body is buckled with the box body to close the accommodation space.

In an embodiment, the driving assembly includes:
a lead screw, an outer peripheral wall of one end of the lead screw is provided with a first thread, an outer peripheral wall of the other end of the lead screw is provided with a second thread, and the first thread and the second thread have opposite rotation directions;
two nut structures sleeved on an outside of the lead screw, one of the nut structures is connected to the first thread, the other one of the nut structures is connected to the second thread, and a bottom end of each of the support arms is rotatably connected to one of the nut structures; and
a motor connected to the lead screw in a driving manner and configured to drive the lead screw to rotate, so that the two nut structures are close to or away from each other.

In an embodiment, the opening and closing apparatus further includes two elastic members symmetrically provided on both sides of a center line of the cover body, and each of the elastic members is elastically connected to a middle part of the cover body and one of the support arms.

In an embodiment, the rooftop solar charging device further includes a second solar panel assembly provided on an outer wall of the cover body and electrically connected to the battery.

In an embodiment, the rooftop solar charging device further includes a mains socket provided on an outer wall of the box body and electrically connected to the battery.

In an embodiment, the rooftop solar charging device further includes a control apparatus configured to control the opening and closing apparatus, the control apparatus is wiredly connected to the opening and closing apparatus and is provided on an outer wall of the box body or the cover body, or the control apparatus is wirelessly connected to the opening and closing apparatus.

In an embodiment, the rooftop solar charging device further includes a display apparatus, at least one of the battery and the first solar panel assembly are electrically connected to the display apparatus.

In an embodiment, the rooftop solar charging device further includes:
a charging cable, one end of the charging cable is electrically connected to the battery, and the other end of the charging cable is configured to pass through the box body and extend to an outside of the accommodation space; and
an electrical connector provided at one end of the charging cable away from the battery and configured to connect to an electrical device.

In an embodiment, the rooftop solar charging device further includes a winding apparatus provided inside the accommodation space and configured to store or release the charging cable to adjust a length of the charging cable extending outside the accommodation space.

In an embodiment, the electrical connector is a charging gun configured to connect to a charging port of a vehicle.

The present application also provides a vehicle, including:
a vehicle body; and
the rooftop solar charging device, and the rooftop solar charging device is provided on a top of the vehicle body.

The rooftop solar charging device in the technical solution of the present application includes a box body, a cover body, a battery, an opening and closing apparatus and a first solar panel assembly. The box body is fixed on the top of a vehicle body. The opening and closing apparatus can drive the cover body to move relative to the box body, so that the cover body and the box body are buckled to form an accommodation space, or the cover body and the box body are separated to open the accommodation space. When the opening and closing apparatus drives the cover body to open the accommodation space, the first solar panel assembly can switch between the storage status and the unfolded status.

In the unfolded status, the first solar panel assembly is unfolded outside the accommodation space, converting solar energy into electric energy and transmitting the generated electric energy to the battery for storage. The electric energy in the battery can be used as the backup power of the vehicle's power battery, thereby extending the vehicle's cruising range and reducing the possibility of the vehicle breaking down in the wild.

In the storage status, the first solar panel assembly is stored inside the accommodation space, saving the space occupied by the first solar panel assembly and reducing the impact of the first solar panel assembly on the appearance and performance of the vehicle. In addition, when the first solar panel assembly is in the storage status and the cover body is buckled with the box body, the box body and the cover body provide protection for the battery and the first solar panel assembly in the accommodation space, preventing the external environment such as rain, snow, dust, and leaves from damaging the battery and the solar energy panel, thereby extending the service life of the rooftop solar charging device.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic structural view of a vehicle according to an embodiment of the present application.

FIG. 2 is a schematic structural view of the vehicle according to an embodiment of the present application.

FIG. 3 is a schematic structural view of a rooftop solar charging device according to an embodiment of the present application.

FIG. 4 is a partial schematic structural view of the rooftop solar charging device according to an embodiment of the present application.

FIG. 5 is a schematic structural view of the rooftop solar charging device according to an embodiment of the present application.

FIG. 6 is a partial enlarged view at A in FIG. 5.

FIG. 7 is a schematic structural view of the rooftop solar charging device according to an embodiment of the present application.

FIG. 8 is a partial enlarged view at B in FIG. 7.

FIG. 9 is a schematic structural view of the rooftop solar charging device according to an embodiment of the present application.

FIG. 10 is a partial schematic structural view of the rooftop solar charging device according to an embodiment of the present application.

FIG. 11 is a partial enlarged view at C in FIG. 10.

FIG. 12 is a schematic structural view of the rooftop solar charging device according to an embodiment of the present application.

The realization of the objective, functional characteristics, and advantages of the present application are further described with reference to the embodiments and accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

It should be noted that if there are directional indications, such as up, down, left, right, front, back, etc, involved in the embodiments of the present application, the directional indications are only used to explain the relative positional relationship, movement, etc. between the components in a specific posture. If the specific posture changes, the directional indication also changes accordingly.

In the present application, unless otherwise specified and limited, the terms “connecting” and “fixing” should be understood in a broad sense, for example, it can be a fixed connection, a detachable connection, integrally connected, mechanically connected, electrically connected, directly connected or indirectly connected through an intermediary, and it can be the internal connectivity of two components or the interaction between two components. Unless otherwise expressly limited, the specific meaning of the above terms in the present application may be understood by those skilled in the art in accordance with specific conditions.

In addition, if there are descriptions related to “first”, “second”, etc. in the embodiments of the present application, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. Besides, the meaning of “and/or” appearing in the application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of protection claimed in the present application.

The present application provides a rooftop solar charging device.

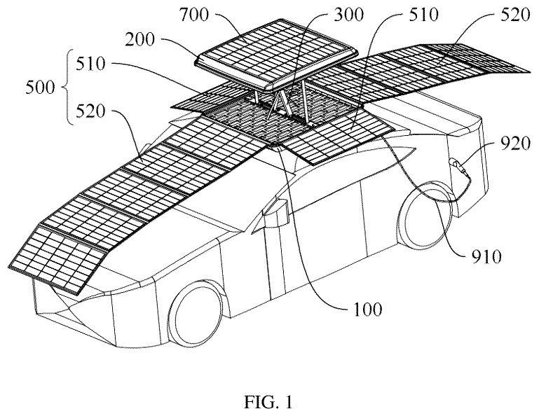

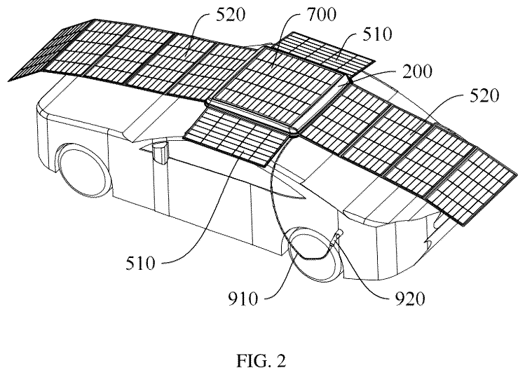

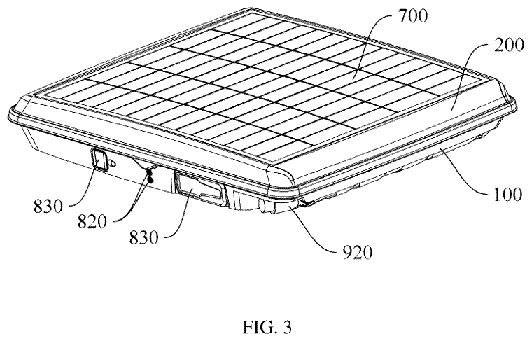

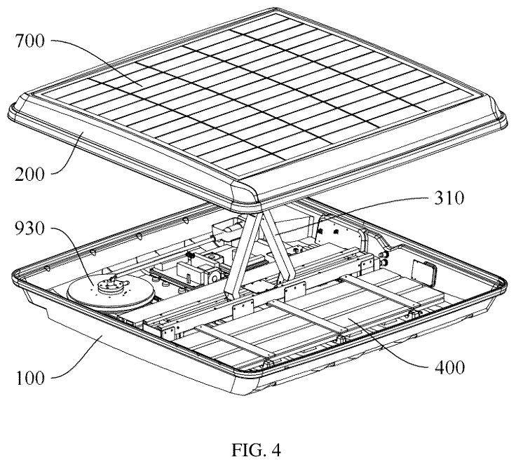

Referring to FIG. 1 to FIG. 4, FIG. 1 is a schematic structural view of a vehicle according to an embodiment of the present application. FIG. 2 is a schematic structural view of the vehicle according to an embodiment of the present application. FIG. 3 is a schematic structural view of a rooftop solar charging device according to an embodiment of the present application. FIG. 4 is a partial schematic structural view of the rooftop solar charging device according to an embodiment of the present application.

In an embodiment of the present application, the rooftop solar charging device includes a box body 100, a cover body 200, an opening and closing apparatus 300, a battery 400, and a first solar panel assembly 500.

The box body 100 is fixed on the top of the vehicle body.

The cover body 200 is provided on one side of the box body 100 away from the vehicle body.

The opening and closing apparatus 300 is provided on one of the box body 100 and the cover body 200 and is configured to drive the other one of the box body 100 and the cover body 200, so that the cover body 200 and the box body 100 are buckled or separated. The cover body 200 and the box body 100 are buckled to form an accommodation space, and the cover body 200 and the box body 100 are separated to open the accommodation space.

The battery 400 is provided inside the accommodation space.

The first solar panel assembly 500 is electrically connected to the battery 400, and has a storage status accommodated inside the accommodation space and an unfolded status unfolded outside the accommodation space. The accommodation space is opened so that the first solar panel assembly 500 can switch between the storage status and the unfolded status.

The rooftop solar charging device in the technical solution of the present application includes a box body 100, a cover body 200, a battery 400, an opening and closing apparatus 300 and a first solar panel assembly 500. The box body 100 is fixed on the top of a vehicle body. The opening and closing apparatus 300 can drive the cover body 200 to move relative to the box body 100, so that the cover body 200 and the box body 100 are buckled to form the accommodation space, or the cover body 200 and the box body 100 are separated to open the accommodation space. When the opening and closing apparatus 300 drives the cover body 200 to open the accommodation space, the first solar panel assembly 500 can switch between the storage status and the unfolded status.

In the unfolded status, the first solar panel assembly 500 is unfolded outside the accommodation space, converts solar energy into electric energy and transmits the generated electric energy to the battery 400 for storage. The electric energy in the battery 400 can be the backup power of the power battery of the vehicle, thereby extending the cruising range of the vehicle and reducing the possibility of the vehicle breaking down in the wild.

In the storage status, the first solar panel assembly 500 is stored inside the accommodation space, saving the space occupied by the first solar panel assembly 500 and reducing the impact of the first solar panel assembly 500 on the appearance and performance of the vehicle. In addition, when the first solar panel assembly 500 is in the storage status and the cover body 200 is buckled with the box body 100, the box body 100 and the cover body 200 provide protection for the battery 400 and the first solar panel assembly 500 in the accommodation space, preventing the external environment such as rain, snow, dust, and leaves from damaging the battery 400 and the solar energy panel, thereby extending the service life of the rooftop solar charging device.

The opening and closing apparatus 300 can adopt a motor, an electric push rod and other forms to drive the cover body 200 to move, so that the cover body 200 can open and close the accommodation space. The battery 400 is fixed inside the accommodation space. The battery 400 can be installed on the box body 100 or the cover body 200. Since the box body 100 is fixed relative to the vehicle body and the cover body 200 moves relative to the box body 100, providing the battery 400 on the box body 100 can make it more secure and reduce the load requirement of the opening and closing apparatus 300.

In an embodiment, the first solar panel assembly 500 includes: a horizontal solar panel 510 and a vertical solar panel 520.

The horizontal solar panel 510 is rotatably connected to the box body 100 and electrically connected to the battery 400, and is accommodated inside the accommodation space or unfolded outside the accommodation space along the width direction of the vehicle body through rotation.

The vertical solar panel 520 is rotatably connected to the box body 100 and electrically connected to the battery 400, and is accommodated inside the accommodation space or unfolded outside the accommodation space along the length direction of the vehicle body through rotation.

Referring to FIG. 1, in an embodiment of the present application, the first solar panel assembly 500 includes a horizontal solar panel 510 and a vertical solar panel 520, both of which are rotatably connected to the box body 100. The horizontal solar panel 510 can be unfolded outside the box body 100 along the width direction of the vehicle through rotation, and the vertical solar panel 520 can be unfolded outside the box body 100 along the length direction of the vehicle through rotation. By providing the horizontal solar panel 510 and the vertical solar panel 520, the total area of the first solar panel assembly 500 receiving solar energy is increased, the absorption efficiency of solar energy is improved, and the utilization rate of the top space of the vehicle is improved.

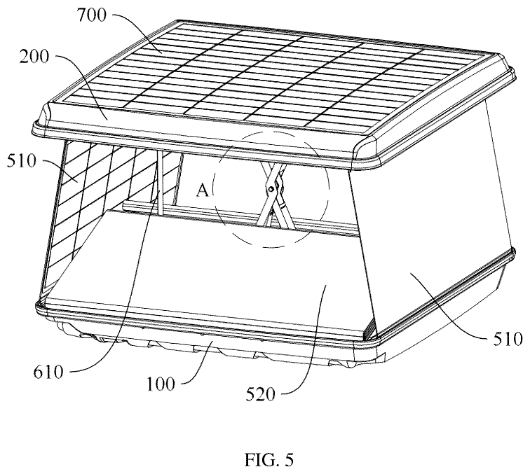

Specifically, referring to FIG. 1, both sides of the box body 100 along the width direction of the vehicle are respectively provided with a horizontal solar panel 510, and the width of each horizontal solar panel 510 is slightly less than half of the width of the box body 100. Both sides of the box body 100 along the length direction of the vehicle are respectively provided with a vertical solar panel 520. In combination with FIG. 1 and FIG. 5, the vertical solar panel 520 includes a plurality of sub-solar energy panels connected end to end and capable of rolling and folding. The width of each sub-solar energy panel is slightly less than half the length of the box body 100. By arranging a plurality of sub-solar energy panels capable of rolling and folding, the area of the vertical solar panel 520 is increased, the absorption efficiency of the first solar panel assembly 500 is further improved, and the utilization rate of the top space of the vehicle is further improved.

Specifically, in this embodiment, the vertical solar panel 520 unfolded towards the front direction of the vehicle includes five sub-solar energy panels, and the vertical solar panel 520 unfolded towards the rear direction of the vehicle includes four sub-solar energy panels, which realizes a large area coverage of the top of the vehicle, and also plays a role in blocking light for the vehicle, thereby preventing the temperature inside the vehicle from overheating in hot weather. The size of each sub-solar energy panel is the same as that of the horizontal solar panel 510, which reduces the types of parts of the first solar panel assembly 500 and improves the processing efficiency and assembly efficiency. When the horizontal solar panel 510 and the vertical solar panel 520 are both stored in the accommodation space, the horizontal solar panel 510 can be stacked on the vertical solar panel 520, or the vertical solar panel 520 can be stacked on the horizontal solar panel 510.

In an embodiment, the rooftop solar charging device further includes a first traction member 610, and the first traction member 610 is made of a flexible material. One end of the first traction member 610 is connected to the box body 100, and the other end of the first traction member 610 is connected to the cover body 200 or the opening and closing apparatus 300. In the process of the cover body 200 opening the accommodation space, the first traction member 610 drives the horizontal solar panel 510 to rotate in the direction of separating from the accommodation space; and/or,
the rooftop solar charging device further includes a second traction member 620, and the second traction member 620 is made of a flexible material. One end of the second traction member 620 is connected to the box body 100, and the other end of the second traction member 620 is connected to the cover body 200 or the opening and closing apparatus 300. In the process of the cover body 200 opening the accommodation space, the second traction member 620 drives the vertical solar panel 520 to rotate in the direction of separating from the accommodation space.

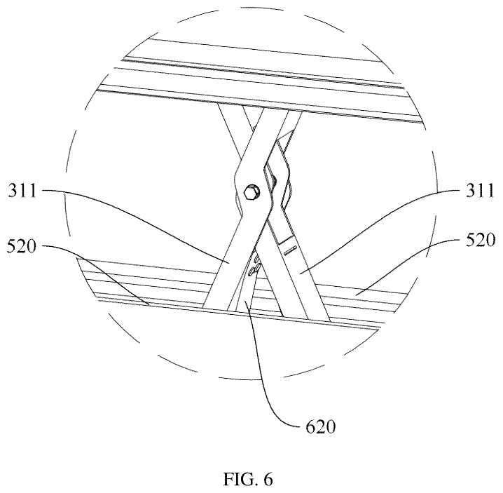

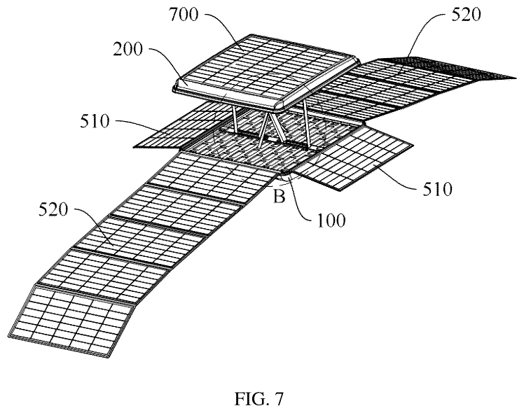

Referring to FIG. 5 to FIG. 9, in an embodiment of the present application, the rooftop solar charging device further includes a first traction member 610. The first traction member 610 can be in the form of a rope, a line, a belt, a chain, etc., and can be made of flexible materials such as fiber and rubber, so that the first traction member 610 is flexible. One end of the first traction member 610 is connected to the box body 100, and the other end of the first traction member 610 is connected to the cover body 200 or the opening and closing apparatus 300.

When the opening and closing apparatus 300 drives the cover body 200 to open the accommodation space, the first traction member 610 follows the cover body 200 or the opening and closing apparatus 300 to move, and drives the horizontal solar panel 510 to rotate in the direction of separating from the accommodation space, so that the horizontal solar panel 510 is inclined at a certain angle, achieving a semi-expanded effect, and facilitating the user to manually operate the horizontal solar panel 510 to continue to expand, which saves time and effort, and improves the convenience of the user when expanding the horizontal solar panel 510. In addition, the first traction member 610 has a simple structure, and is easy to manufacture, which has a low production cost.

Specifically, in this embodiment, when the cover body 200 closes the accommodation space, the distance between the cover body 200 and the box body 100 is small, and the first traction member 610 is folded on both sides of the horizontal solar panel 510. As the cover body 200 is opened, the distance between the cover body 200 and the box body 100 increases, and the first traction member 610 is gradually tightened, thereby driving the horizontal solar panel 510 to rotate in the direction of separating from the accommodation space.

Referring to FIG. 5 to FIG. 9, in an embodiment of the present application, the rooftop solar charging device further includes a second traction member 620. The second traction member 620 can be in the form of a rope, a line, a belt, a chain, etc., and can be made of flexible materials such as fiber and rubber, so that the second traction member 620 is flexible. One end of the second traction member 620 is connected to the box body 100, and the other end of the second traction member 620 is connected to the cover body 200 or the opening and closing apparatus 300. When the opening and closing apparatus 300 drives the cover body 200 to open the accommodation space, the second traction member 620 follows the cover body 200 or the opening and closing apparatus 300 to move, and drives the vertical solar panel 520 to rotate in the direction of separating from the accommodation space, so that the vertical solar panel 520 is inclined at a certain angle, achieving a semi-expanded effect, and facilitating the user to continue to expand the vertical solar panel 520 manually, which saves time and effort, and improves the convenience of the user when expanding the vertical solar panel 520. In addition, the second traction member 620 has a simple structure, and is easy to manufacture, which has a low production cost.

Specifically, in this embodiment, when the cover body 200 closes the accommodation space, the distance between the cover body 200 and the box body 100 is small, and the second traction member 620 is folded on both sides of the vertical solar panel 520. As the cover body 200 is opened, the distance between the cover body 200 and the box body 100 increases, and the second traction member 620 is gradually tightened, thereby driving the vertical solar panel 520 to rotate in the direction of separating from the accommodation space.

The lengths and the positions of the first traction member 610 and the second traction member 620 can be set correspondingly according to the stacking sequence of the horizontal solar panel 510 and the vertical solar panel 520. For example, when the first solar panel assembly 500 is in the storage status, if the horizontal solar panel 510 is stacked on the vertical solar panel 520, then in the process of the cover body 200 opening the accommodation space, it is necessary to firstly drive the horizontal solar panel 510 to rotate through the first traction member 610, and drive the vertical solar panel 520 to rotate through the second traction member 620. Therefore, the first traction member 610 is connected to the cover body 200 and the box body 100 and is far away from the center of the box body 100, and the second traction member 620 is connected to the middle part of the opening and closing apparatus 300 and the box body 100 and is close to the center of the box body 100. In the initial stage when the cover body 200 is far away from the box body 100, only the first traction member 610 is driven to be gradually tightened. As the cover body 200 continues to get away from the box body 100, the second traction member 620 is driven to be gradually tightened, so as to realize the rotation of the horizontal solar panel 510 first and the rotation of the vertical solar panel 520, avoiding interference or collision during the semi-expansion of the horizontal solar panel 510 and the semi-expansion of the vertical solar panel 520, and improving the smoothness of opening the accommodation space and unfolding the first solar panel assembly 500.

In an embodiment, the opening and closing apparatus 300 includes a scissor assembly 310 and a driving component.

The scissor assembly 310 includes two support arms 311, the middle parts of the two support arms 311 are crossed and rotatably connected, and the top ends of the two support arms 311 are both slidably connected to the cover body 200.

The driving component is configured to drive the bottom ends of the two support arms 311.

The driving component drives the bottom ends of the two support arms 311 to approach each other, so that the cover body 200 is away from the box body 100 to open the accommodation space; or the driving component drives the bottom ends of the two support arms 311 to move away from each other, so that the cover body 200 is buckled with the box body 100 to close the accommodation space.

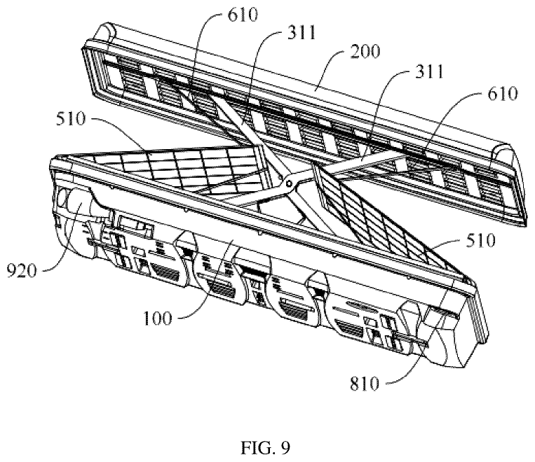

Referring to FIG. 4 and FIG. 9, in an embodiment of the present application, the opening and closing apparatus 300 includes a scissor assembly 310 and a driving component. The driving component drives two support arms 311 of the scissor assembly 310 to change the crossing angle, so that the cover body 200 descends and engages with the box body 100 to close the accommodation space, or the cover body 200 rises and separates from the box body 100 to open the accommodation space. The cover body 200 is driven by the scissor assembly 310 to move closer to or away from the box body 100 in a vertical lifting manner. On the one hand, the structure is simple and the scissor assembly 310 is easy to process and assemble. On the other hand, the top ends of the two support arms 311 respectively form a connection point with the cover body 200. The two connection points make it easier for the cover body 200 to maintain a stable posture when it is stationary or moving, thereby facilitating the improvement of the positioning accuracy and repeated positioning accuracy of the cover body 200, ensuring that the accommodation space is tightly closed when the cover body 200 is buckled on the box body 100, and further improving the protection effect of the box body 100 and the cover body 200 on the internal components of the accommodation space. On the other hand, the scissor assembly 310 and the driving component can be provided in the accommodation space, so that the box body 100 and the cover body 200 can protect the opening and closing apparatus 300 and extend the service life of the opening and closing apparatus 300.

In an embodiment, the driving assembly includes a lead screw, a nut structure and a motor.

A first thread is provided on the outer peripheral wall of one end of the lead screw, a second thread is provided on the outer peripheral wall of the other end of the lead screw, and the first thread and the second thread have opposite rotation directions.

Two nut structures are provided and are sleeved on the outside of the lead screw, one of the nut structures is connected to the first thread, the other one of the nut structures is connected to the second thread, and the bottom end of each support arm 311 is rotatably connected to the nut structure.

The motor is configured to drive the lead screw to rotate so that the two nut structures are close to or away from each other.

In an embodiment of the present application, the driving assembly includes a motor, a lead screw and two nut structures. The lead screw and the two nut structures respectively form a lead screw nut mechanism. Since the rotation directions of the first thread and the second thread are opposite, when the lead screw rotates, the two nut structures will approach or move away from each other along the axial direction of the lead screw, to drive the bottom ends of the two support arms 311 to approach or move away from each other, thereby changing the crossing angle of the two support arms 311, and making the cover body 200 to open or close the accommodation space. The driving component drives the scissor assembly 310 in the form of a lead screw nut mechanism, which has a high movement accuracy, and improves the accuracy and stability of the movement of the cover body 200, thereby ensuring the tightness of the cover body 200 when it is buckled on the box body 100, and ensuring the protection effect of the cover body 200 and the box body 100 on the parts inside the accommodation space. In addition, the movement of the two support arms 311 is realized by the motor and the lead screw, which not only simplifies the number of parts and reduces the manufacturing cost, but also improves the synchronization of the movement of the two support arms 311, and reduces the possibility of the cover body 200 being skewed due to the asynchronous movement of the two support arms 311.

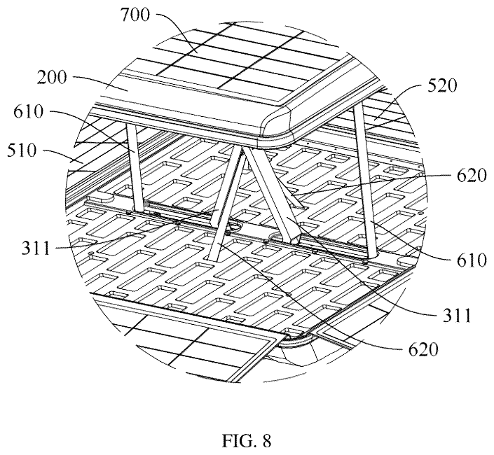

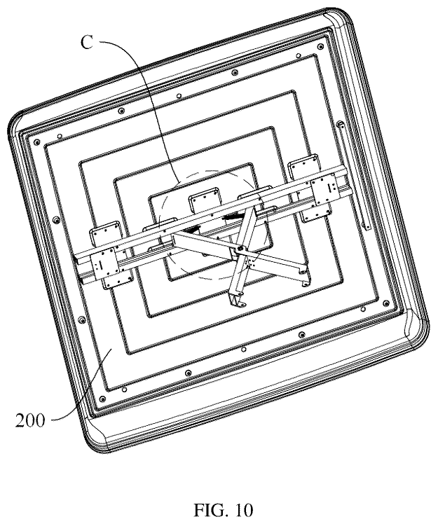

Specifically, in this embodiment, referring to FIG. 8, a first sliding rail is provided on the box body 100, the first sliding rail is provided with a first sliding groove, the lead screw is provided in the first sliding groove, and the bottom ends of the two support arms 311 are both extended into the first sliding groove and move along the first sliding groove. Referring to FIG. 10, a second sliding rail is provided on the cover body 200, and the second sliding rail is provided with a second sliding groove, and the top ends of the two support arms 311 are both extended into the second sliding groove and move along the second sliding groove. By providing the first sliding groove and the second sliding groove, the moving directions of the two support arms 311 are guided, and the possibility of the movement deviation of the two support arms 311 is reduced, thereby reducing the possibility of the opening and closing apparatus 300 being stuck, and improving the smoothness of the opening and closing of the cover body 200.

In an embodiment, the opening and closing apparatus 300 further includes two elastic members 320 symmetrically provided on both sides of the midline of the cover body 200, and each of the elastic members 320 is elastically connected to the middle of the cover body 200 and the support arm 311.

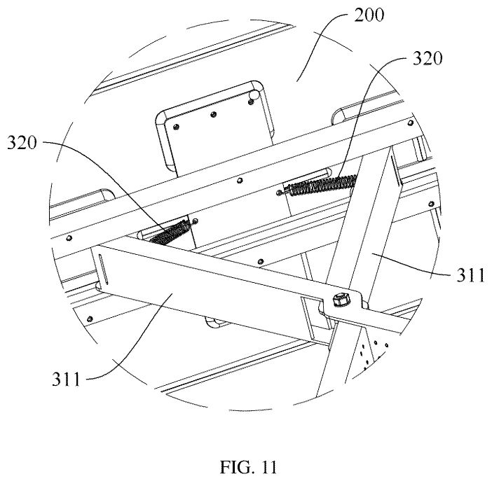

Referring to FIG. 10 to FIG. 11, in an embodiment of the present application, the opening and closing apparatus 300 further includes two elastic members 320 symmetrically provided on both sides of the midline of the cover body 200, and the midline is perpendicular to the plane formed by the intersection of the two support arms 311. The axis of each of the elastic members 320 is parallel to the plane formed by the intersection of the two support arms 311. When the two support arms 311 change the intersection angle, since each of the elastic members 320 is elastically connected to the middle part of the cover body 200 and the support arm 311, the two elastic members 320 will be deformed to the same extent under the action of the corresponding support arm 311, and the same elastic force will be generated on the cover body 200, so that the center of the cover body 200 is always located in the middle of the top ends of the two support arms 311, thereby preventing the cover body 200 from deviating to one side and keeping the cover body 200 centered during the lifting process. On the other hand, the elastic member 320 is connected to the support arm 311 and the cover body 200, the connection strength between the opening and closing apparatus 300 and the cover body 200 is enhanced, and the possibility of the cover body 200 and the opening and closing apparatus 300 being separated and damaged is reduced.

In an embodiment, the rooftop solar charging device further includes a second solar panel assembly 700 provided on the outer wall of the cover body 200 and electrically connected to the battery 400; and/or, the rooftop solar charging device further includes a mains socket 810 provided on the outer wall of the box body 100 and electrically connected to the battery 400; and/or, the rooftop solar charging device further includes a control apparatus 820 configured to control the opening and closing apparatus 300. The control apparatus 820 is wiredly connected to the opening and closing apparatus 300 and is provided on the outer wall of the box body 100 or the cover body 200, or the control apparatus 820 is wirelessly connected to the opening and closing apparatus 300; and/or, the rooftop solar charging device further includes a display apparatus 830, and at least one of the battery 400 and the first solar panel assembly 500 is electrically connected to the display apparatus 830.

Referring to FIG. 1, in an embodiment of the present application, the rooftop solar charging device further includes a second solar panel assembly 700, which increases the area of the solar energy panel, further improves the absorption efficiency of the rooftop solar charging device for solar energy, and further improves the utilization rate of the vehicle top space. The second solar panel assembly 700 can be provided on the top wall of the cover body 200, or on the outer side wall of the cover body 200. Specifically, in this embodiment, the second solar panel assembly 700 is provided on the top wall of the cover body 200, and a whole solar energy panel with a large area is adopted, which is easy to process and easy to assemble.

Referring to FIG. 2, in this embodiment, after the horizontal solar panel 510 and the vertical solar panel 520 are unfolded outside the accommodation space, the opening and closing apparatus 300 drives the cover body 200 to descend and close the accommodation space, so as to prevent leaves, dust, etc. from entering the accommodation space during the process of absorbing solar energy, thereby reducing the difficulty of cleaning the accommodation space and extending the service life of the internal parts of the accommodation space.

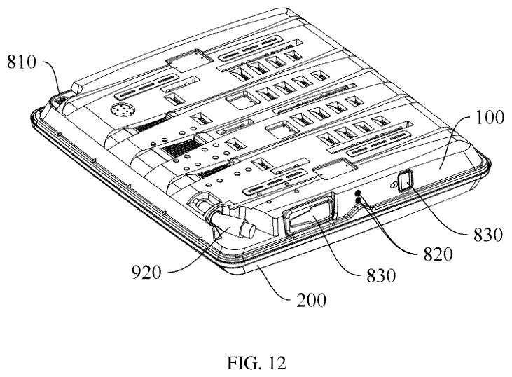

Referring to FIG. 9 and FIG. 12, in an embodiment of the present application, the rooftop solar charging device further includes a mains socket 810. When the mains power is available, the user can directly use the mains power to charge the battery 400, thereby improving the efficiency of charging the battery 400 and extending the vehicle's range. When in the wild, the user can choose to use a solar energy panel to charge the battery 400 to reduce the possibility of the vehicle breaking down. By providing the mains socket 810, the flexibility of charging the battery 400 is improved.

Referring to FIG. 3 and FIG. 12, in an embodiment of the present application, the rooftop solar charging device further includes a control apparatus 820 configured to control the start and stop of the opening and closing apparatus 300, so that the cover body 200 opens or closes the accommodation space. The control apparatus 820 may be a switch provided on the box body 100 or the cover body 200, and directly connected to the opening and closing apparatus 300 through a wire. The control apparatus 820 may also be a remote controller, and controls the opening and closing apparatus 300 through a wireless connection.

Referring to FIG. 3 and FIG. 12, in an embodiment of the present application, the rooftop solar charging device further includes a display apparatus 830, and the display apparatus 830 may be one or more display screens, indicator lights, etc. The display apparatus 830 is connected to the battery 400, and is configured to display the charging status of the battery 400, for example: displaying the current power percentage of the battery 400, the remaining charging time, the voltage of the battery 400, etc. The display apparatus 830 is connected to the first solar panel assembly 500 and the second solar panel assembly 700, and is configured to display the working status of the solar energy panel, for example: displaying the current power generation, and the power generation, etc. The display apparatus 830 is provided to facilitate the user to obtain necessary information, enhance the user's understanding of the device status, and improve the convenience of using the device.

In an embodiment, the rooftop solar charging device further includes a charging cable 910 and an electrical connector.

One end of the charging cable 910 is electrically connected to the battery 400, and the other end of the charging cable 910 passes through the box body 100 and extends to the outside of the accommodation space.

The electrical connector is provided at the end of the charging cable 910 away from the battery 400 and is configured to connect to an electrical device.

Referring to FIG. 1, in an embodiment of the present application, the rooftop solar charging device further includes a charging cable 910 and an electrical connector. The user can use the charging cable 910 and the electrical connector to supply power to the electrical device with the electric energy in the battery 400. The electrical device can be a power battery of a vehicle, or an electric oven, an outdoor air conditioner, a mobile phone, etc. It is sufficient to only provide a corresponding electrical connector, thereby improving the practicality and convenience of the rooftop solar charging device.

Specifically, in this embodiment, the rooftop solar charging device also includes a maximum power point tracking (MPPT) controller and an inverter. The unfolded solar energy panel absorbs solar energy and converts it into direct current. The direct current is stabilized by the MPPT controller and is transmitted to the battery 400 for storage. The battery 400 supplies power to the inverter, and the inverter converts the direct current into alternating current, then charges the electrical equipment through the charging cable 910 and the electrical connector.

In an embodiment, the rooftop solar charging device also includes a winding apparatus 930 provided inside the accommodation space and configured to store or release the charging cable 910 to adjust the length of the charging cable 910 extending outside the accommodation space; and/or,
the electrical connector is a charging gun 920 configured to connect to the charging port of the vehicle.

Referring to FIG. 4 and FIG. 12, in an embodiment of the present application, the rooftop solar charging device further includes a winding apparatus 930 for storing or releasing a charging cable 910, so that the charging cable 910 can be retracted or extended as needed to adapt to different usage scenarios. The charging cable 910 can be orderly stored inside the accommodation space when not in use, which not only saves space but also avoids the clutter of the charging cable 910, thereby improving the convenience of using the rooftop solar charging device.

Referring to FIG. 1 and FIG. 2, in an embodiment of the present application, the electrical connector is a charging gun 920 configured to charge an electric vehicle, and can charge the vehicle where the rooftop solar charging device is located, and can also charge other vehicles, further improving the practicality of the rooftop solar charging device. Using solar energy to charge the power battery of the vehicle reduces dependence on the power grid, saves energy, reduces the operating cost of the vehicle, and also reduces the possibility of the vehicle breaking down in the wild. Specifically, in this embodiment, referring to FIG. 12, a bayonet for the charging cable 910 to pass through is provided on the box body 100. When the charging cable 910 is stored in the accommodation space through the winding apparatus 930, the charging gun 920 is inserted into the bayonet and fixed by the bayonet to prevent the charging gun 920 and the charging cable 910 from falling during driving, thereby extending the service life and improving driving safety. In addition, a sealing ring is also provided at the periphery of the bayonet, and the sealing ring is configured to seal the inner wall of the bayonet and the charging gun 920 to prevent water in the external environment from entering the accommodation space.

The present application also provides a vehicle, including a vehicle body and the above-mentioned rooftop solar charging device. The rooftop solar charging device is provided on the top of the vehicle body.

The specific structure of the rooftop solar charging device refers to the above-mentioned embodiment. Since the present vehicle adopts all the technical solutions of the above-mentioned embodiments, it has at least all the beneficial effects brought by the technical solutions of the above-mentioned embodiments, which will not be described one by one here.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields, are included in the scope of the present application.

What is claimed is:

1. A rooftop solar charging device, comprising:
a box body fixed on a top of a vehicle body;
a cover body provided on one side of the box body away from the vehicle body;
an opening and closing apparatus provided on one of the box body and the cover body and connected to the other one of the box body and the cover body in a driving manner, wherein the cover body and the box body are buckled to form an accommodation space, and the cover body and the box body are separated to open the accommodation space;
a battery provided inside the accommodation space; and
a first solar panel assembly electrically connected to the battery, having a storage status accommodated inside the accommodation space and an unfolded status unfolded outside the accommodation space; wherein in response to that the accommodation space is opened, the first solar panel assembly is configured to switch between the storage status and the unfolded status.

2. The rooftop solar charging device of claim 1, wherein the first solar panel assembly comprises:
a horizontal solar panel rotatably connected to the box body and electrically connected to the battery, wherein the horizontal solar panel is accommodated inside the accommodation space or unfolded outside the accommodation space along a width direction of the vehicle body through rotation; and
a vertical solar panel rotatably connected to the box body and electrically connected to the battery, wherein the vertical solar panel is accommodated inside the accommodation space or unfolded outside the accommodation space along a length direction of the vehicle body through rotation.

3. The rooftop solar charging device of claim 2, further comprising a first traction member made of a flexible material, wherein one end of the first traction member is connected to the box body, and the other end of the first traction member is connected to the cover body or the opening and closing apparatus; and
in a process of the cover body opening the accommodation space, the first traction member is configured to drive the horizontal solar panel to rotate in a direction of separating from the accommodation space.

4. The rooftop solar charging device of claim 2, further comprising a second traction member made of a flexible material, wherein one end of the second traction member is connected to the box body, and the other end of the second traction member is connected to the cover body or the opening and closing apparatus, and
in a process of the cover body opening the accommodation space, the second traction member is configured to drive the vertical solar panel to rotate in a direction of separating from the accommodation space.

5. The rooftop solar charging device of claim 1, wherein the opening and closing apparatus comprises:
a scissor assembly comprising two support arms, wherein middle parts of the two support arms are crossed and rotatably connected, and top ends of the two support arms are slidably connected to the cover body; and
a driving assembly connected to bottom ends of the two support arms in a driving manner;
wherein the driving assembly is configured to drive the bottom ends of the two support arms to approach each other, so that the cover body is configured to move away from the box body to open the accommodation space; or
the driving assembly is configured to drive the bottom ends of the two support arms to move away from each other, so that the cover body is buckled with the box body to close the accommodation space.

6. The rooftop solar charging device of claim 5, wherein the driving assembly comprises:
a lead screw, wherein an outer peripheral wall of one end of the lead screw is provided with a first thread, an outer peripheral wall of the other end of the lead screw is provided with a second thread, and the first thread and the second thread have opposite rotation directions;
two nut structures sleeved on an outside of the lead screw, wherein one of the nut structures is connected to the first thread, the other one of the nut structures is connected to the second thread, and a bottom end of each of the support arms is rotatably connected to one of the nut structures; and
a motor connected to the lead screw in a driving manner and configured to drive the lead screw to rotate, so that the two nut structures are close to or away from each other.

7. The rooftop solar charging device of claim 5, wherein the opening and closing apparatus further comprises two elastic members symmetrically provided on both sides of a center line of the cover body, and each of the elastic members is elastically connected to a middle part of the cover body and one of the support arms.

8. The rooftop solar charging device of claim 1, further comprising a second solar panel assembly provided on an outer wall of the cover body and electrically connected to the battery.

9. The rooftop solar charging device of claim 1, further comprising a mains socket provided on an outer wall of the box body and electrically connected to the battery.

10. The rooftop solar charging device of claim 1, further comprising a control apparatus configured to control the opening and closing apparatus, wherein the control apparatus is wiredly connected to the opening and closing apparatus and is provided on an outer wall of the box body or the cover body, or the control apparatus is wirelessly connected to the opening and closing apparatus.

11. The rooftop solar charging device of claim 1, further comprising a display apparatus, wherein at least one of the battery and the first solar panel assembly are electrically connected to the display apparatus.

12. The rooftop solar charging device of claim 1, further comprising:
a charging cable, wherein one end of the charging cable is electrically connected to the battery, and the other end of the charging cable is configured to pass through the box body and extend to an outside of the accommodation space; and
an electrical connector provided at one end of the charging cable away from the battery and configured to connect to an electrical device.

13. The rooftop solar charging device of claim 12, further comprising a winding apparatus provided inside the accommodation space and configured to store or release the charging cable to adjust a length of the charging cable extending outside the accommodation space.

14. The rooftop solar charging device of claim 12, wherein the electrical connector is a charging gun configured to connect to a charging port of a vehicle.

15. A vehicle, comprising:
a vehicle body; and
the rooftop solar charging device of claim 1, wherein the rooftop solar charging device is provided on a top of the vehicle body.
